(19) United States
(12) Patent Application Publication
(10) Pub. No.: US 2004/0249934 A1
(43) Pub. Date: Dec. 9, 2004

(54) Updating print server software based on update emails

(76) Inventors: Jeff M. Anderson, Camas, WA (US); Jeremy E. Bunn, Kelso, WA (US); Daniel N. Revel, Portland, OR (US)

Correspondence Address: HEWLETT-PACKARD COMPANY, Intellectual Property Administration, P.O. Box 272400, Fort Collins, CO, 80527-2400, US

(21) Appl. No.: 10/456,101

(22) Filed: Jun. 6, 2003

(51) Int. Cl. G06F 15/173; G06F 15/16; G06F 9/44

(52) U.S. Cl. 709/224; 709/206; 717/171

(57) ABSTRACT

A print server system includes an email onramp configured to receive emails via a network. The email onramp is configured to distinguish between received print emails that specify print operations and received update emails that include software updates. The server system includes a print job controller that is configured to orchestrate the printing of documents based on print emails received via the onramp. The server system includes a software update controller configured to automatically update software within the server system based on software updates in update emails received via the onramp.

### THE FIELD OF THE INVENTION

The present invention generally relates to print servers, and more particularly to updating print server software based on update emails.

### BACKGROUND OF THE INVENTION

Recent years have seen a proliferation of portable electronic devices such as personal digital assistants (PDA's), cellular telephones, and/or other portable electronic devices. For example, personal digital assistants are now available such as the HP Jornada manufactured by Hewlett-Packard Company based in Palo Alto, Calif., or the Blackberry™ manufactured by Research in Motion™ Limited based in Ontario, Canada as well as other brands. These mobile devices offer a range of capabilities, including mobile calendars, organizing capabilities, and electronic mail received and transmitted via a mobile pager network or other mobile networks, etc.

Unfortunately, these devices are typically limited in their capabilities due to the fact that they are limited in their processing capacity and memory size. For example, many such devices cannot execute the many different applications that are available for the average personal computer. Specifically, such devices may not be able to implement word processors or other extensive applications. When it comes to activities such as printing, such devices are typically unable to perform various tasks such as rendering documents in printer compatible form.

Hewlett-Packard Company currently offers a Mobile Enterprise Printing (MEP) product, which is a server-based software solution that enables users of mobile devices to print files, web pages, and email messages (including attachments) to printers on a corporate network. Information regarding Hewlett-Packard's MEP product is available on the Internet at http://www.hp.com/go/mep.

Software updates for print servers, such as a server running the Hewlett-Packard MEP product, are typically delivered on a compact disk, or as a file that is downloaded from a server, such as a server that hosts a website. When a user accesses a website to download software updates, the user manually logs onto the website and essentially “pulls” the information from the website. Once the software update is obtained, a user (typically a network administrator) manually installs the update. Applying a software update typically requires that the software be temporarily shut down, thus disabling its capabilities for a period of time. In addition, the print server or similar device may be located in a server room that is not conveniently accessible.

### SUMMARY OF THE INVENTION

One form of the present invention provides a print server system that includes an email onramp configured to receive emails via a network. The email onramp is configured to distinguish between received print emails that specify print operations and received update emails that include software updates. The server system includes a print job controller that is configured to orchestrate the printing of documents based on print emails received via the onramp. The server system includes a software update controller configured to automatically update software within the server system based on software updates in update emails received via the onramp.

### BRIEF DESCRIPTION OF THE DRAWINGS

FIG. 1 is a block diagram illustrating a mobile print network according to one embodiment of the present invention.

FIG. 2 is a block diagram illustrating major components of the mobile print server shown in FIG. 1 according to one embodiment of the present invention.

FIG. 3 is a block diagram illustrating software components of the mobile print server shown in FIG. 1 according to one embodiment of the present invention.

FIG. 4 is a flow diagram illustrating a method for updating software components of the mobile print server shown in FIG. 1 according to one embodiment of the present invention.

### DESCRIPTION OF THE PREFERRED EMBODIMENTS

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

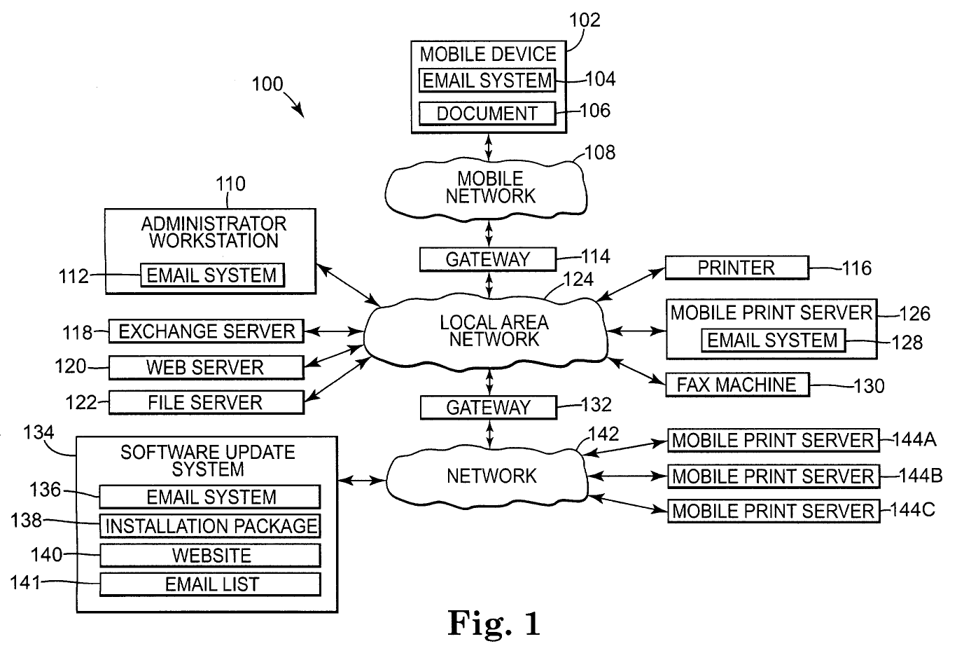

FIG. 1 is a block diagram illustrating a mobile print network 100 according to one embodiment of the present invention. The mobile print network 100 includes a mobile network 108, a local area network 124, and a network 142. Mobile network 108 is coupled to local area network 124 via gateway 114. Local area network 124 is coupled to network 142 via gateway 132. The mobile network 108 may comprise, for example, a pager network or cellular network that accommodates wireless transmission to mobile devices as is generally known by those with ordinary skill in the art. The network 142 may be, for example, the Internet, a wide area network, or other network, or a combination of such networks.

Mobile device 102 is communicatively coupled to mobile network 108. Administrator workstation 110, network printer 116, exchange server 118, web server 120, file server 122, mobile print server 126, and facsimile (fax) machine 130 are coupled to local area network 124. Software update system 134 and mobile print servers 144A-144C (collectively referred to as mobile print servers 144) are coupled to network 142. In one form of the invention, mobile print servers 144 are each connected to a separate local area network, but are shown connected to a single network 142 to simplify the illustration. In one embodiment, administrator workstation 110, exchange server 118, web server 120, file server 122, mobile print server 126, software update system 134, and mobile print servers 144 are computer systems or devices with like capability.

Mobile device 102, administrator workstation 110, mobile print server 126, and software update system 134 include email systems 104, 112, 128, and 136, respectively. As contemplated herein, email refers to data information exchange using the Simple Mail Transfer Protocol (SMTP) or like protocol over a communications network, such as networks 108, 124, and/or 142. In one embodiment, mobile print servers 144 are each configured in substantially the same manner as mobile print server 126, and each mobile print server 144 also includes an email system.

In one embodiment, the mobile device 102 is a personal digital assistant (PDA), cellular telephone, or other such device that typically lacks either the computing power to render and/or print a document stored therein, or lacks an application, such as an appropriate driver to perform such tasks. The mobile print network 100 is employed to facilitate email printing from mobile device 102. Specifically, a user of the mobile device 102 generates an email print message using the email system 104, and attaches any documents (e.g., document 106) thereto for printing. In one embodiment, the email message is addressed using an email address that is associated with the mobile print server 126. Included within the email print message is the printer name or other identifier of a printer (e.g., network printer 116) on the local area network 124 or other network.

The email print message is transmitted from mobile device 102 to mobile network 108, through gateway 114, and to local area network 124, where the email print message is received by mobile print server 126. In another embodiment, the mobile print server 126 may interface with exchange server 118 to obtain an email print message that was originally received by the server 118.

Upon receiving the email print message, the mobile print server 126 performs such tasks as are necessary to cause the email and the attached document(s) 106 to be printed on the network printer 116, including rendering the email and the attached documents into a printer ready format appropriate for the specified printer 116. The specific steps and/or logic employed within one embodiment of the mobile print server 126 to accomplish such tasks are described in greater detail in U.S. patent application Ser. No. 09/884,594, filed Jun. 18, 2001, entitled “System and Method for Mobile Printing”, and published on Dec. 19, 2002 as Publication No. US 2002/0191210 A1; U.S. patent application Ser. No. 09/884,598, filed Jun. 18, 2001, entitled “System and Method for Configuring a Printing System”, published on Dec. 19, 2002 as Publication No. US 2002/0191211 A1; and U.S. patent application Ser. No. 09/884,600, filed Jun. 18, 2001, entitled “System and Method for Remote Document Retrieval”, published on Dec. 19, 2002 as Publication No. US 2002/0194307 A1; which are commonly assigned and hereby incorporated by reference herein.

As an alternative to specifying one or more printers in the email print message, or in addition to specifying such printers, a user of mobile device 102 may also specify a facsimile machine 130 in the email print message. Upon receiving such an email print message, the mobile print server 126 performs such tasks as are necessary to cause the facsimile machine 130 to output a hard copy of the email and any attached document(s) 106.

One embodiment of mobile print network 100 provides a user of mobile device 102 with remote access to documents (or other files) stored on the web server 120 and/or the file server 122. In one form of the invention, the user remotely accesses such documents by generating a request for a document in the form of an email message using the email system 104 of the mobile device 102. In one embodiment, the request email message includes the directory location and file name of the document to be retrieved. The request email message is transmitted from mobile device 102 to mobile print server 126. When the mobile print server 126 receives the request email message, the server 126 retrieves the requested document from the web server 120 or the file server 122, and generates a reply email message. The mobile print server 126 attaches the requested document to the reply email message and automatically transmits the reply email message with the attached document back to the mobile device 102.

In addition, if the user of mobile device 102 wishes to print the document retrieved from the web server 120 or the file server 122, then the user may specify a destination address (e.g., a printer identifier) for the document in the request email message that is transmitted to the mobile print server 126. The mobile print server 126 then causes the retrieved document to be printed by the printer specified in the request email message.

One embodiment of the present invention provides automatic updating of software within mobile print servers 126 and 144 via email from software update system 134. An operator of software update system 134 maintains a software update email list 141 that identifies email addresses associated with mobile print servers 126 and 144 that are configured to receive software updates via email. In one embodiment, the email list 141 includes email addresses for mobile print servers 126 and 144, and for local enterprise administrators. When a new software update becomes available, a software update email is generated using email system 136, and an installation package 138 is created for the update. The installation package 138 may have different configurations (e.g., complete upgrade, partial update, patch, etc.).

The installation package 138 is attached to the software update email. In one embodiment, the software update email with the attached installation package 138 is transmitted to each email address in the software update email list 141. In the case of an email address for a mobile print server 126 or 144, the software update email is delivered directly to the mobile print server 126 or 144. In the case of an email address for a local enterprise administrator, the software update email includes instructions regarding how to forward the software update email to the local mobile print server 126 or 144.

By sending a software update email to a local enterprise administrator, rather than directly to a mobile print server 126 or 144, the local enterprise administrator has an opportunity to review and approve software updates before allowing them to be applied. For example, a local enterprise administrator may receive a software update email using email system 112 of administrator workstation 110. If the software update is acceptable to the administrator, the administrator manually forwards the software update email using email system 112 to mobile print server 126, which automatically applies the update.

In one embodiment, each mobile print server 126 or 144 that receives a software update email authorizes the sender to ensure that the sender has permission to perform the update, and if permission is granted, the mobile print server 126 or 144 automatically applies the installation package 138 to itself, thereby updating the software in the mobile print server 126 or 144. The software update email may be received directly from the software update system 134, or may be a forwarded message from a local enterprise administrator.

In one form of the invention, software update system 134 provides a subscription based update scheme, where an administrator of a mobile print server 126 or 144 subscribes to the software update email list 141. In one embodiment, software update system 134 includes a web site 140 that allows administrators to sign up for email updates. As part of the sign up process, the administrator can specify that the email updates be emailed to the administrator's email address, or directly to an email address for a mobile print server 126 or 144. In one aspect of the invention, software updates are deployed automatically via email by software update system 134 as the updates are made available by the software provider.

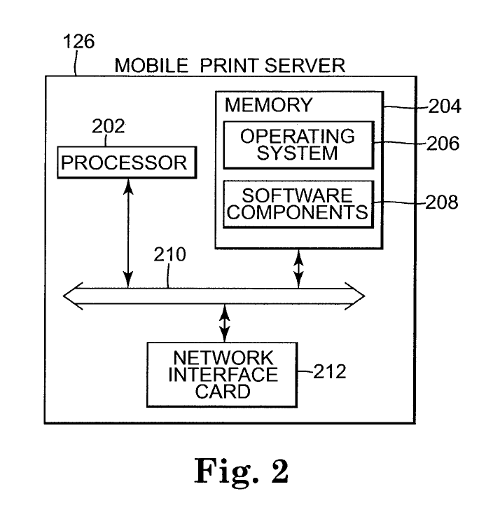

FIG. 2 is a block diagram illustrating major components of the mobile print server 126 shown in FIG. 1 according to one embodiment of the present invention. Mobile print server 126 includes a processor 202 and a memory 204, both of which are coupled to a local interface 210. In one embodiment, the local interface 210 is a data bus with an accompanying control/address bus as is generally known by those with ordinary skill in the art. The mobile print server 126 also includes a network interface card 212 that couples the mobile print server 126 to the local area network 124 (FIG. 1).

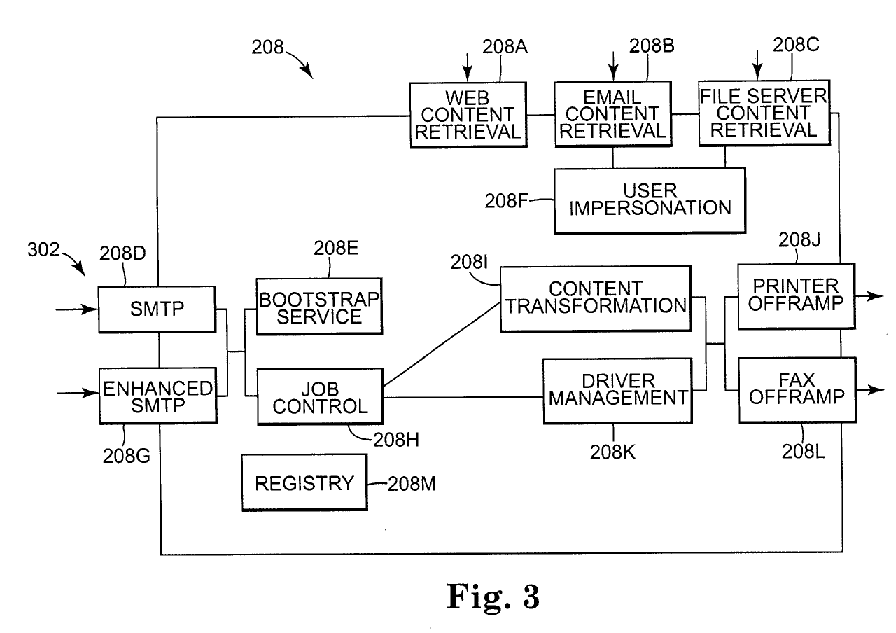

Stored in the memory 204 and executable by the processor 202 are an operating system 206 and software components or subsystems 208. The operating system 206 is executed, for example, to control the allocation and usage of hardware resources in the mobile print server 126. Specifically, the operating system 206 controls the allocation and usage of various portions of the memory 204, processing time, and peripheral devices, as well as performing other functions. In this manner, the operating system 206 serves as the foundation on which applications depend as is generally known by those with ordinary skill in the art. Software components 208 are described in further detail below with reference to FIG. 3.

The memory 204 may include both volatile and nonvolatile memory components. Volatile components are those that do not retain data values upon loss of power. Nonvolatile components are those that retain data upon a loss of power. Thus, the memory 204 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

FIG. 3 is a block diagram illustrating software components 208A-208M (collectively referred to as software components or subsystems 208) of the mobile print server 126 shown in FIG. 1 according to one embodiment of the present invention. Software components 208 include web content retrieval component 208A, email content retrieval component 208B, file server content retrieval component 208C, SMTP component 208D, bootstrap service component (software update controller) 208E, user impersonation component 208F, enhanced SMTP component 208G, job control component 208H, content transformation component 2081, printer offramp component 208J, driver management component 208K, fax offramp component 208L, and registry component 208M. In one embodiment, components 208 are Java® components written in the Java® programming language.

Components 208A, 208B, 208C, 208D, 208G, 208J, and 208L have an external interface to communicate with devices external to mobile print server 126. SMTP component 208D and enhanced SMTP component 208G receive emails from local area network 124, process the received emails, and then pass the emails on to other software components 208. Enhanced SMTP component 208G provides support for print options that are not supported by SMTP component 208G. SMTP component 208D and enhanced SMTP component 208G are collectively referred to herein as email onramp 302.

For each received email, email onramp 302 identifies whether the email is a print email that specifies a print (or fax) job, or whether the email is a software update email. Email onramp 302 forwards print emails to job control component 208H, and forwards software update emails to bootstrap service component 208E.

Web content retrieval component 208A communicates with web server 120 (FIG. 1) or other web servers to retrieve content from the web server 120. Email content retrieval component 208B communicates with exchange server 118 (FIG. 1) or a domino server to retrieve email messages. File server content retrieval component 208C communicates with file server 122 (FIG. 1) to retrieve files from the server 122.

User impersonation component 208F provides user identification data (e.g., username and password) to the email content retrieval component 208B and the file server content retrieval component 208C, which may be needed by these components 208B and 208C to impersonate the user of mobile device 102 (FIG. 1) and retrieve the data requested by the user. In one embodiment, a user specifies his or her user identification data in an email print message sent to mobile print server 126.

Job control component 208H is responsible for managing print jobs, and helps to ensure that received email print messages are routed to the appropriate components 208, and that the print job is properly completed. Content transformation component 2081 renders a document having an input file type into a file having an output file type. In one embodiment, the input file types include types such as Microsoft Office 97/2000/XP (Word, Powerpoint, Excel), HTML, PDF, and graphics (e.g., JPG, GIF, BMP, etc.), as well as other file types, and the output file types include printer-ready formats such as Postscript, printer control language (PCL), G4 TIFF for fax, as well as others. If mobile print server 126 does not have a driver for a printer specified by a user, driver management component 208K is invoked to retrieve a driver for the specified printer.

Printer offramp component 208J communicates with a printer specified by a user of mobile device 102 to send the printer-ready data to the printer. Printer offramp component 208J also keeps track of any errors that occur during the printing process, and communicates these errors back to the user of mobile device 102. Fax offramp component 208L communicates with a fax machine specified by a user of mobile device 102 to send the printer-ready data (e.g., G4 TIFF) to the fax machine.

In one embodiment, before providing a software update email to bootstrap service component 208E, email onramp 302 performs sender authorization verification, and sender authentication operations. In one embodiment, after identifying that a received email is a software update email, email onramp 302 examines the “from” field in the email message to identify the sender of the email, compares the identified sender to a list of entities that are authorized to provide software updates, and determines whether the email message was sent by an authorized entity. In one form of the invention, email onramp 302 also performs an authentication routine to ensure that the entity that sent the software update email is authentic (i.e., the sender is the person that he or she represents himself or herself to be).

In one form of the invention, email onramp 302 is configured to only accept signed software update email messages from trusted entities. In one embodiment, email onramp 302 uses Secure Multipart Internet Mail Extensions (S/MIME), which is a public standard for signing and authenticating email messages. In another embodiment, another authentication scheme is used, such as server certificates, or encrypted signatures using public and private encryption keys. In one form of the invention, email onramp 302 is configured to accept software update emails based on one of the following four rules: (1) Only accept software update emails signed by a local enterprise administrator; (2) Only accept software update emails signed by the service software provider; (3) Only accept software update emails signed by both a local enterprise administrator and the service software provider; or (4) Only accept software update emails signed by either a local enterprise administrator or the service software provider. In another embodiment, email onramp 302 is also configured to accept software update emails from one or more authorized third party software providers. For example, a third party software provider may develop a software add-on that provides additional functionality for mobile print server 126. If the third party provider is authorized to do so, the provider can send the add-on to one or more mobile print servers 126, which would automatically install the add-on.

If email onramp 302 determines that the sender of a software update email is authorized to send such emails, and that the sender is authentic, email onramp 302 forwards the software update email to bootstrap service component 208E. If email onramp 302 determines that the sender of a software update email is not authorized or is not authentic, email onramp 302 discards the received software update email.

Bootstrap service component 208E extracts the installation package 138 from a received software update email, and determines the best way to apply the installation package 138. In one embodiment, each installation package 138 includes a set of compressed (e.g., zipped) files and an installation information file. The installation information file contains information regarding how the software update is to be performed, including the components 208 that need to be stopped to install the update, where the files are to be unzipped to, and how to register or bind the components to the system. The files in an installation package 138 can be the complete set of printer server software components 208, or can be a subset of all of the components 208.

In one embodiment, bootstrap service component 208E decompresses the compressed files in the installation package 138, extracts and saves any configuration data that needs to be preserved during the update, installs the decompressed files according to the instructions in the installation information file, and updates the installed software based on the saved configuration data. Bootstrap service component 208E is configured to take the server 126 to a safe state for application of the software installation package 138. If the bootstrap service component 208E determines that a received installation package 138 can be dynamically applied while the mobile print server 126 continues to process print jobs, then the component 208E immediately applies the installation package 138 while server 126 is processing print jobs. If the bootstrap service component 208E determines that one or more of the other components 208 need to be stopped to apply the installation package 138, component 208E gracefully takes these other individual components 208 down prior to replacing or patching these components 208.

In one embodiment, if bootstrap service component 208E determines that an installation package 138 cannot be applied dynamically (i.e., while server 126 is processing print jobs), bootstrap service component 208E identifies when mobile print server 126 is idle (i.e., is not currently processing print jobs). Bootstrap service component 208E then stops the other software components 208 during idle time, applies the installation package 138, and then brings up the new and/or updated software components 208. The bootstrap service component 208E is separate from the other components 208, which allows component 208E to stop all of the other components 208, a subset of the other components 208 including a single component 208, or selectively replace individual class files, dynamically linked libraries (DLL's), or other fine-grained software components.

In one embodiment, software components 208 are substantially independent of one another, so an individual software component 208 or a subset of the software components 208 may be selectively taken down and replaced by one or more updated software components 208 without requiring the entire system to be shut down.

After installing a software update, any new or updated software components 208 are registered with registry component 208M. Registry component 208M keeps track of all of the other software components 208 in server 126. Each individual software component 208 that is up and running registers itself with registry component 208M. If two components 208 need to communicate with each other, registry component 208M provides these components 208 with an appropriate interface to communicate with each other. After new or updated software components 208 are registered with registry component 208M, other software components 208 in server 126 are able to find and communicate with the newly installed components.

In another embodiment of the present invention, software update system 134 leverages existing installation engines to install software updates for mobile print server 126. In this embodiment, installation package 138 is an executable file that includes an installation engine, or that includes instructions for an installation engine that is part of operating system 206 (FIG. 2). In one embodiment, such existing installation engines that might be used include InstallShield®, Wise®, and MSI Script™. When an existing installation engine is used to facilitate the software update, bootstrap service component 208E is invoked in one embodiment to assist the installation engine in stopping components 208 that need to be stopped to install the software update.

In one embodiment, after bootstrap service component 208E installs a software update, bootstrap service component 208E initiates a basic functionality test (i.e., a “smoke test”) to test the basic functionality of the system. In one embodiment, mobile print server 126 includes a suite of tests that may be invoked to test the functionality of the system. The replaced software components 208 and the installation instructions are preserved after the software update, so that if the basic functionality test indicates a problem, bootstrap service component 208E “rolls back” the software update, so that the system is put in the same state it was in before the update.

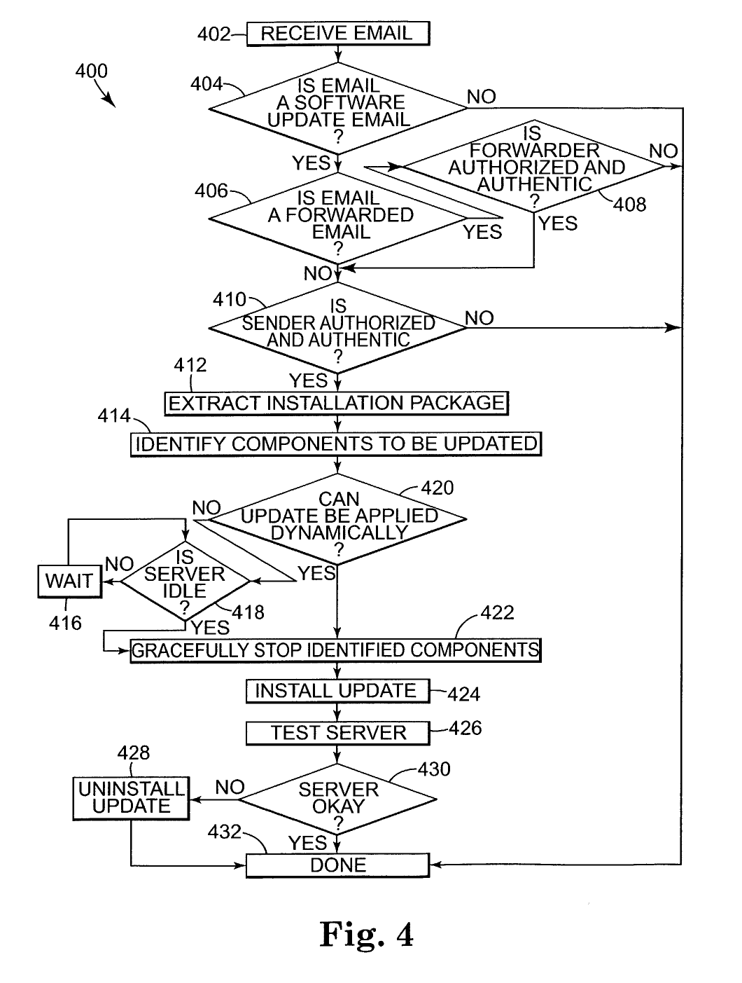

FIG. 4 is a flow diagram illustrating a method 400 for updating software components 208 of the mobile print server 126 shown in FIG. 1 according to one embodiment of the present invention. In one embodiment, mobile print server 126 is configured to perform method 400.

In step 402, email onramp 302 (FIG. 3) of mobile print server 126 receives an email. In step 404, email onramp 302 determines whether the received email is a software update email. If email onramp 302 determines that the received email is not a software update email, the method 400 moves to step 432, which indicates that the method 400 is done.

If email onramp 302 determines in step 404 that the received email is a software update email, email onramp 302 next determines in step 406 whether the received email is a forwarded email that has been forwarded, for example, by a local enterprise administrator. If the received email is not a forwarded email, the method 400 moves to step 410 (described below). If email onramp 302 determines in step 406 that the received email is a forwarded email, email onramp 302 next determines in step 408 whether the entity that forwarded the software update email is an authorized sender, and whether the sender is authentic. If email onramp 302 determines that the sender that forwarded the email is not authorized or is not authentic, email onramp 302 discards the received email and the method moves to step 432, which indicates that the method 400 is done. If email onramp 302 determines in step 408 that the sender that forwarded the email is both authorized and authentic, the method moves to step 410.

In step 410, email onramp 302 determines whether the entity that originally sent the software update email is an authorized sender, and whether the sender is authentic. If email onramp 302 determines that the original sender is not authorized or is not authentic, email onramp 302 discards the received email and the method moves to step 432, which indicates that the method 400 is done. If email onramp 302 determines in step 410 that the original sender is both authorized and authentic, the method moves to step 412.

In step 412, the received software update email is forwarded to bootstrap service component 208E (FIG. 3), which extracts the installation package 138 from the email. In step 414, based on the contents of the installation package 138, bootstrap service component 208E identifies the software components 208 that are to be updated.

In step 420, bootstrap service component 208E determines whether the software update can be applied dynamically (i.e., while mobile print server 126 is processing print jobs). If the software update can be applied dynamically, the method 400 moves to step 422 (described below). If bootstrap service component 208E determines in step 420 that the software update cannot be applied dynamically, bootstrap service component 208E next determines in step 418 whether the mobile print server 126 is idle (i.e., not currently processing any print jobs). If mobile print server 126 is idle, the method moves to step 422. If bootstrap service component 208E determines in step 418 that the mobile print server 126 is not idle, in step 416, bootstrap service component 208E waits for a predetermined period of time, and then the method returns to step 418. Thus, the bootstrap service component 208E waits until the mobile print server 126 is idle before moving from step 418 to step 422.

In step 422, bootstrap service component 208E gracefully stops the software components 208 to be replaced or updated, which were identified in step 414. In step 424, bootstrap service component 208E installs the installation package 138, thereby replacing or updating one or more of the other software components 208.

In step 426, after installation of the software update has been performed, bootstrap service component 208E tests the functionality of mobile print server 126. In step 430, bootstrap service component 208E examines the results of the functionality test and determines whether the mobile print server 126 is functioning okay, or whether there is a problem with the operation of the server 126. If it is determined in step 430 that the mobile print server 126 is operating okay with the newly installed software, the method 400 is done, as indicated by step 432. If there is a problem with the mobile print server 126 operating with the newly installed software, in step 428, bootstrap service component 208E uninstalls the software update, and the method 400 moves to step 432, which indicates that the method 400 is done.

It will be understood by a person of ordinary skill in the art that functions performed by software update system 134 and mobile print server 126 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

One form of the present invention provides an enhanced mobile print server that includes an email onramp to not only receive print jobs, but also to receive software updates that are automatically verified and applied by the server. By using email to apply software updates, as is done in one form of the invention, the mobile print server can apply the software update to itself at a convenient time, such as when it is not currently in use. In one embodiment, the software update can be administered to the mobile print server from any email client, which makes the process more convenient. The ability to deliver server patches via email according to one form of the invention provides a convenient mechanism to ensure that customer software is up-to-date.

The ability to deliver software updates via email as done in one form of the invention is a valuable service tool, and may be used by a customer call center for supporting customers and ensuring that the customers are on the most recent code base. The customer call center would have access to all of the latest software updates. If a customer called the center with a problem, the service employee could identify that the problem could be fixed if the customer's device were upgraded to a newer version of software. With the customer's permission, the service employee would email a software update to the customer's machine, which would automatically apply the update. In this way, the service employee does not have to explain to the customer how the customer can download a particular update, and the steps necessary to install that update. In one form of the invention, software updates are “pushed” to customers via email when the updates become available, rather than requiring the customers to “pull” the updates from the software provider (e.g., downloading updates from a website).

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A print server system, comprising:
an email onramp configured to receive emails via a network, the email onramp configured to distinguish between received print emails that specify print operations and received update emails that include software updates;
a print job controller configured to orchestrate the printing of documents based on print emails received via the onramp; and
a software update controller configured to automatically update software within the server system based on software updates in update emails received via the onramp.

2. The print server system of claim 1, wherein the email onramp is configured to verify that a sender of a received update email is an authorized sender.

3. The print server system of claim 2, wherein the email onramp is configured to discard received update emails from a sender that is not verified as being an authorized sender.

4. The print server system of claim 2, wherein the email onramp is configured to perform an authentication operation to verify that the sender of a received update email is authentic.

5. The print server system of claim 1, wherein the email onramp is configured to receive a forwarded update email that includes a software update, the forwarded update email sent from a first sender to a second sender, and manually forwarded from the second sender to the server system, and wherein the software update controller is configured to automatically update software within the server system based on the forwarded update email.

6. The print server system of claim 5, wherein the email onramp is configured to verify that at least one of the first and the second senders is an authorized sender.

7. The print server system of claim 6, wherein the email onramp is configured to perform an authentication operation to verify that at least one of the first and the second senders is authentic.

8. The print server system of claim 5, wherein the email onramp is configured to verify that both of the first and the second senders are authorized senders.

9. The print server system of claim 8, wherein the email onramp is configured to perform an authentication operation to verify that both of the first and the second senders are authentic.

10. The print server system of claim 1, wherein the software within the server system includes a plurality of substantially independent software components, and wherein the software update controller is configured to dynamically update selected ones of the software components while the print server system is processing a print email.

11. The print server system of claim 10, wherein the software components are Java software components.

12. The print server system of claim 1, wherein the software update controller is configured to identify when the print server system is idle, and automatically update the software within the server system when the print server system is identified as being idle.

13. The print server system of claim 12, wherein the software update controller is configured to identify that the print server system is idle if the print server system is not currently processing any print emails.

14. The print server system of claim 1, wherein the software update controller is configured to test the print server system after updating the software within the server system.

15. The print server system of claim 14, wherein the software update controller is configured to automatically uninstall a software update if the test of the print server system indicates a problem with operation of the print server system.

16. A method for updating software of a plurality of print servers, the method comprising:
maintaining an email list including a plurality of email addresses, each email address in the email list associated with at least one of the print servers;
sending an email message with a software update attached thereto to each of the email addresses in the email list;
receiving the email message at each of the print servers;
verifying at each of the print servers that the received email message is from an authorized source; and
each print server automatically detaching the software update from the email message and automatically updating software of the print server based on the software update if the email message is verified as being from an authorized source.

17. The method of claim 16, wherein the plurality of email addresses includes first and second sets of email addresses, each email address in the first set identifying an address for one of the print servers, each email address in the second set identifying an address for a person.

18. The method of claim 17, wherein the email message received by at least one of the print servers is a forwarded email that has been manually forwarded to the print server by a person with an email address in the second set.

19. The method of claim 16, and further comprising:
each print server verifying that a source of the received email message is authentic.

20. The method of claim 16, and further comprising:
each print server identifying when the print server is idle, and performing the step of automatically updating the software when the print server is identified as being idle.

21. A server system to facilitate email printing, the system comprising:
means for receiving emails;
means for distinguishing between print emails that specify print requests and software update emails that include software updates;
means for orchestrating the printing of documents based on received print emails;
means for verifying that a sender of a software update email is an authorized sender; and
means for automatically installing the software update in the server system if the sender is verified as being an authorized sender.

22. The server system of claim 21, and further comprising:
means for verifying authenticity of a sender of a software update email.

23. The server system of claim 21, wherein the means for receiving emails is configured to receive a forwarded software update email that includes a software update, the forwarded update email sent from a first sender to a second sender, and manually forwarded from the second sender to the server system, and wherein the means for automatically installing the software update is configured to automatically install in the server system the software update from the forwarded software update email.

24. The server system of claim 23, wherein the means for receiving emails further comprises:
means for verifying that at least one of the first and the second senders is an authorized sender, and discarding the forwarded software update email if at least one of the first and the second senders is not an authorized sender.

25. The server system of claim 23, wherein the means for receiving emails further comprises:
means for verifying that both of the first and the second senders are authorized senders, and discarding the forwarded software update email if both of the first and the second senders are not authorized senders.

26. The server system of claim 21, wherein the means for automatically installing the software update further comprises:
means for identifying when the server system is idle; and
wherein the means for automatically installing the software update is configured to wait until the server system is identified as being idle before installing the software update.

27. A computer-readable medium having computer-executable instructions for performing a method of updating software of a print server, the method comprising:
receiving emails with the print server;
determining whether each received email is a print email specifying a print request or a software update email that includes a software update attached thereto;
verifying that each received software update email is from an authorized sender; and
automatically updating software of the print server based on received software update emails.
